(19) United States
(12) Patent Application Publication
(10) Pub. No.: US 2008/0034316 A1
(43) Pub. Date: Feb. 7, 2008

(54) SCALABLE SCROLLBAR MARKERS

(76) Inventor: Johan Thoresson, Goteborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/461,471

(22) Filed: Aug. 1, 2006

(51) Int. Cl. G06F 9/00

(52) U.S. Cl. 715/781; 715/786; 715/784; 715/785

(57) ABSTRACT

An electronic equipment is provided that includes a display and a display control for presenting a window and an image within the window to the display. The window includes at least one scrollbar for altering at least one of a horizontal position or a vertical position of the window relative to the image within in the window. In addition, the electronic equipment includes a user input, operatively coupled to the display control, for engaging the at least one scrollbar in order to effect a zoom function with respect to the image displayed in the window.

### TECHNICAL FIELD OF THE INVENTION

The present invention relates generally to graphical user interfaces, and more particularly to scrollbars used in a window environment.

### DESCRIPTION OF THE RELATED ART

In the vast number of computer systems and other types of electronic equipment available today, the interface between the user and the electronic equipment is a graphical interface on a visual display. In many very widespread types of electronic equipment, the operating system presents in the graphical interface a “window” through which applications such as word processing, spreadsheets, database, media, etc. are viewed. It is common in applications to create electronic documents that are also depicted graphically in the visual display. In order to create documents, applications have a variety of features and controls. One common way of accessing these features and controls is by moving a graphical cursor over the graphical display of the feature by some manner of position indicator. The feature is then often activated by the object position indicator itself.

Numerous devices are available or have been proposed for use as position indicators for use in computer systems and other types of electronic equipment. The most familiar of such devices is the computer “mouse”. Trackball devices are similar to mouse devices. A major difference, however is that, unlike a mouse device, a trackball device does not require a surface across which it must be rolled. Further, there are several available touch-sense technologies that may be employed for use as a position indicator. For example, resistive and/or capacitive membrane position indicators are known and used in several applications.

Referring to FIGS. 1A-1C, an exemplary window 10 is shown within a display 12. In order to be effectively employed the window 10 must be capable of being moved, or scrolled, in a vertical and/or a horizontal direction across an image displayed within the window 10. A scrollbar 14 is a well known structure used to visualize the movement of the window 10 across the image. An example of a system that employs scrollbars is virtually every Windows®—based Operating System commercially available from Microsoft Corp.

The scrollbar 14 is often used in conjunction with the position indicator, such as a mouse, trackball, or touch-sensitive screen. When the window 10 is too small in either the horizontal or vertical dimension, relative to the dimensions of the image being presented, one or more scrollbars 14 are presented to the user. The vertically disposed scrollbar 14 of FIGS. 1A-1C can be seen to contain a scrollbar marker 16 that may be moved vertically up or down. As the user moves the scrollbar marker 16 in the desired direction, the relative position of the window 10 is moved across the image displayed therein accordingly. This provides a rapid and efficient method for the user to scroll the window 10 vertically and/or horizontally (using the horizontal scrollbar 14 and marker 16) across the image. Many applications that present information on a display utilize this technique to good advantage. Examples of applications using scrollbars include text editors, spread sheets and graphics applications.

In addition to providing a means by which a user can scroll across an image to manipulate what is displayed in the window, conventional scrollbars 14 also provide information. In one instance, the position of the scrollbar marker 16 within the overall scrollbar 14 indicates to the user what part of the image is currently displayed (e.g., left, right, upper, lower, middle, etc.). For example, a comparison of FIGS. 1A and 1B illustrates how the position of the scrollbar marker 16 in the vertical scrollbar 14 indicates whether the window is displaying the middle or upper portion of the image, respectively.

In another instance, the size of the scrollbar marker 16 within the overall scrollbar 14 indicates to the user how large a part of the image is currently displayed. A comparison of FIGS. 1A and 1C, for example, illustrates how the length of each of the horizontal and vertical scrollbar markers 16 indicates whether the window is displaying a larger (zoom-out) or smaller (zoom-in) portion of the image, respectively. Typically, the shorter the length of the scrollbar markers 16 relative to the overall length of the scrollbars 14 indicate the more closely zoomed in (or smaller portion) of the image is currently displayed.

Thus, for example, a user may be viewing a display 10 as shown in FIG. 1A. The user may decide it is desirable to zoom-in on a feature of the image presented in the window. Typically, the user must select a “zoom-in” tool available from a menu toolbar in a given application. The user must then apply the tool, typically by way of the position indicator. FIG. 1C illustrates a case where the user applies the zoom-in tool at the center of the image as displayed in FIG. 1A. The result is a zoom in function is performed and an enlarged center portion of the image is displayed as in FIG. 1C. Consequently, the size of the scrollbar markers 16 within the scrollbars 14 becomes reduced. In a “zoom-out” operation, the opposite occurs as will be appreciated.

Despite the ease and utility of conventional scrollbars 14 as described above, there are in fact some shortcomings. One particular problem relates to the scrollbars 14 being limited in how they allow a user to manipulate the information provided by the scrollbars 14. In the case of position information, a user may engage the scrollbar 14 itself by either clicking or pointing on the scrollbar end arrows 18 using the position indicator, or by clicking/pointing-and-dragging the scrollbar marker 16 with the position indicator so as to alter the position of the window relative to the image. On the other hand, a user may not simply engage the scrollbar 14 itself in order to alter the relative size of the image displayed within the window. Rather, as described above the user must select a “zoom-in” or “zoom-out” tool typically from a menu tool bar or the like. The user must then apply the tool to the image, independent of the scrollbar 14, in order to alter the size. This of course requires multiple applications of the position indicator (e.g., mouse, trackball, stylus on a touch-sensitive display, etc.) and/or other control buttons or features. It is not possible for the user to alter the size, or “zoom” level, simply by engaging the scrollbar 14 itself.

In view of the aforementioned shortcomings associated with the use of existing scrollbars, there is a strong need in the art for a scrollbar configuration and method that allows a user to alter the size of the image displayed in the window without requiring an excessive number of applications of the position indicator, etc. More specifically, there is a strong need in the art for a scrollbar configuration and method that allows a user to alter the size of the image simply by engaging the scrollbar itself.

### SUMMARY

According to one particular aspect of the invention, an electronic equipment is provided. The electronic equipment includes a display and a display control for presenting a window and an image within the window to the display, the window including at least one scrollbar for altering at least one of a horizontal position or a vertical position of the window relative to the image within in the window. In addition, the electronic equipment includes a user input, operatively coupled to the display control, for engaging the at least one scrollbar in order to effect a zoom function with respect to the image displayed in the window.

In accordance with another aspect, the user input includes a position indicator, and the display control is configured to cause the display to display a zoom control icon when the position indicator is in close proximity to a scrollbar marker included in the at least one scrollbar.

According to another aspect, the zoom control icon allows a user to increase or decrease the length of the scrollbar marker to effect the zoom function.

In accordance with still another aspect, the display control causes the display to display the zoom control icon when the position indicator is in close proximity to an end of the scrollbar marker.

According to yet another aspect, the display is a touchscreen display and the placement of the position indicator is controlled via the touchscreen display.

With yet another aspect, the user input includes a position indicator, and the display control is configured to effect the zoom function as a function of the position indicator selecting a scrollbar marker included in the at least one scrollbar for at least a predetermined amount of time.

According to another aspect, the display control effects the zoom function in a first direction upon a single select and hold operation by the position indicator, and effects the zoom function in a second direction upon a double select and hold operation by the position indicator.

According to still another aspect, the display is a touchscreen display and the placement of the position indicator and selection of the scrollbar marker is controlled via the touchscreen display.

In accordance with yet still another aspect, the user input includes a position indicator, and the display control is configured to cause the display to display zoom control selection items when the position indicator is in close proximity to a scrollbar marker included in the at least one scrollbar.

According to another aspect, the zoom control selection items include a zoom in selection item and a zoom out selection item.

According to another particular aspect of the invention, a method for controlling an electronic equipment is provided. The electronic equipment includes a display; a display control for presenting a window and an image within the window to the display, the window including at least one scrollbar for altering at least one of a horizontal position or a vertical position of the window relative to the image within in the window; and a user input. The method includes the steps of engaging the at least one scrollbar with the user input to effect a zoom function with respect to the image displayed in the window.

In accordance with still another aspect, the user input includes a position indicator, and the display control is configured to cause the display to display a zoom control icon when the position indicator is placed in close proximity to a scrollbar marker included in the at least one scrollbar.

According to another aspect, the method includes the step of increasing or decreasing the length of the scrollbar marker using the zoom control icon to effect the zoom function.

In accordance with yet another aspect, the display control causes the display to display the zoom control icon when the position indicator is placed in close proximity to an end of the scrollbar marker.

With still another aspect, the display is a touchscreen display and the placement of the position indicator is controlled via the touchscreen display.

With yet another aspect, the method includes the step of selecting a scrollbar marker included in the at least one scrollbar for at least a predetermined amount of time in order to effect the zoom function.

In still another aspect, the display control effects the zoom function in a first direction upon a single select and hold operation of the at least one scrollbar, and effects the zoom function in a second direction upon a double select and hold operation of the at least one scrollbar.

In accordance with another aspect, the display is a touchscreen display and the selection of the scrollbar marker is controlled via the touchscreen display.

According to another aspect, the display control is configured to cause the display to display zoom control selection items when the scrollbar marker is addressed by the user input.

According to yet another aspect, the zoom control selection items include a zoom in selection item and a zoom out selection item.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIGS. 1A, 1B and 1C illustrate a conventional electronic equipment display using scrollbars;

FIGS. 2A and 2B illustrate an electronic equipment display using scrollbars in accordance with a first embodiment of the present invention;

FIGS. 3A and 3B illustrate an electronic equipment display using scrollbars in accordance with a second embodiment of the present invention;

FIGS. 4A and 4B illustrate an electronic equipment display using scrollbars in accordance with a third embodiment of the present invention;

FIG. 5 is a system flowchart suitable for programming an electronic equipment to provide scrollbar operation in accordance with the first embodiment of FIGS. 2A and 2B;

FIG. 6 is a system flowchart suitable for programming an electronic equipment to provide scrollbar operation in accordance with the second embodiment of FIGS. 3A and 3B;

FIG. 7 is a system flowchart suitable for programming an electronic equipment to provide scrollbar operation in accordance with the third embodiment of FIGS. 4A and 4B;

FIG. 8 is a perspective view of an exemplary electronic equipment in accordance with the present invention; and

FIG. 9 is a functional block diagram of the exemplary electronic equipment of FIG. 8 in accordance with the present invention.

### DETAILED DESCRIPTION OF EMBODIMENTS

The present invention will now be described with reference to the drawings, wherein like reference numerals are used to refer to like elements throughout.

Unlike conventional scrollbars, the scrollbars of the present invention enable a user to alter the size or “zoom” level of an image displayed in a window simply by engaging the scrollbar itself. There is no need for the user to first access a zoom-in, zoom-out, or other type tool and apply the tool to the image.

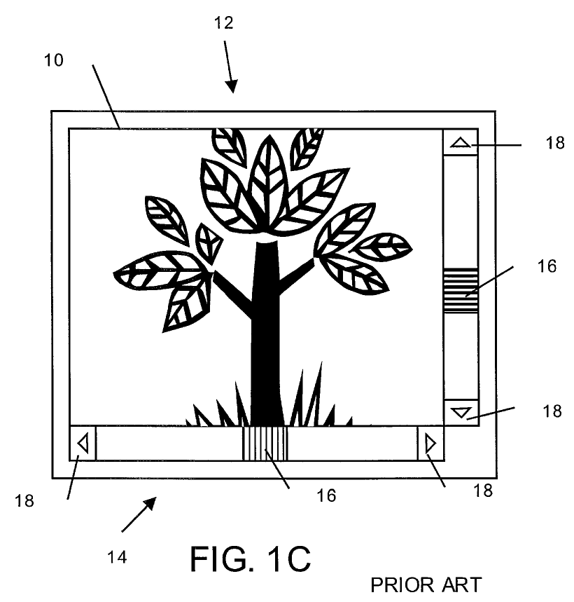

Referring initially to FIGS. 2A and 2B, a first embodiment of the present invention is illustrated. An exemplary window 20 is shown within a display 22 of an electronic equipment. The window 20 displays an image that can be a text document, spreadsheet, media image, etc. The specific content of the image displayed within the window 20 is not germane to the invention and can be any type of image whatsoever without departing from the scope of the invention.

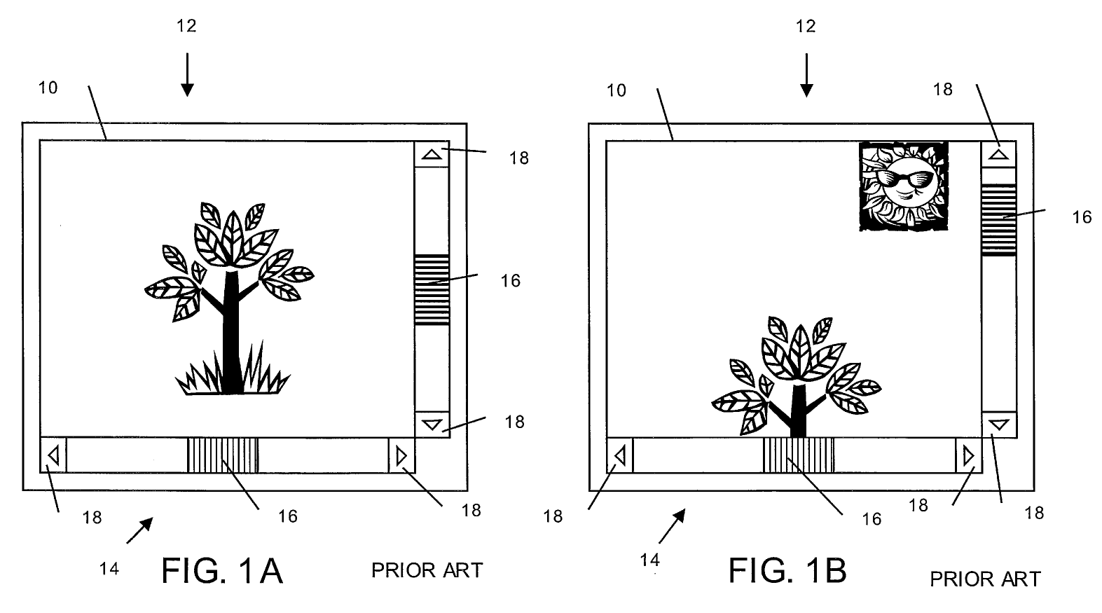

Similar to the window 10 discussed above in relation to FIGS. 1A-1C, the window 20 includes horizontal and vertical scrollbars 24 each having it's own respective scrollbar marker 26. Except as otherwise described herein, the scrollbars 24 including the scrollbar markers 26, function exactly in the same manner as conventional scrollbars such as the scrollbars 14 with scrollbar markers 16 described above with respect to FIGS. 1A-1C. For sake of brevity, only the differences between the present invention and conventional scrollbars will be described below.

According to the embodiment of FIGS. 2A and 2B, as a user moves a cursor 30 via a position indicator (e.g., mouse, trackball, etc.) in close proximity to either edge of the scrollbar marker 26, the position of the cursor 30 causes a zoom control icon 32 to appear. Then, by clicking and dragging on the zoom control icon 32 at the edge of the scrollbar marker 26 using the position indictor (e.g., cursor 30), the user may increase or decrease the length of the scrollbar marker 26. In accordance with the invention, the increasing or decreasing of the length of the scrollbar marker 26 causes the display controller within the electronic equipment to zoom out or zoom in relative to the displayed image, respectively.

For example, it is well known in the aforementioned Windows® Operating Systems how placing the cursor near an edge of a window, box, etc. may be used to cause another control icon to appear. For example, when a user wishes to resize a box, the user simply moves the cursor near the edge of the box. A control icon will automatically appear on the display, and the user may click and drag on the control icon so as to change the size of the box.

The same techniques may be utilized in accordance with the present invention. In the embodiment of FIGS. 2A and 2B, as the user moves the cursor 30 near the upper edge of the scrollbar marker 26 of the vertical scrollbar 24, the electronic equipment causes the zoom control icon 32 to appear as represented in FIG. 2A. By clicking on the zoom control icon 32 and dragging it vertically downward in the downward direction of arrow A, the length of the scrollbar marker 26 is shortened as represented in FIG. 2B. The electronic equipment recognizes such user input action and in turn causes the image within the window 20 to become enlarged (i.e., zoomed in). Conversely, if the zoom control icon 32 is dragged vertically upward in the upward direction of arrow A, the length of the scrollbar marker 26 will be increased. In this case, the electronic equipment recognizes such user input action and in turn causes the image size within the window 20 to become reduced (i.e., zoomed out) (not shown). Similar operation occurs with respect to the horizontal scrollbar 24.

In the exemplary embodiments described herein, the size of the scrollbar markers 26 increase/decrease in proportion to the amount of zoom out/in, as will be appreciated. However, such proportional change is not necessary in the broadest sense of the invention.

The positioning of the cursor 30 and the click-and-dragging of the zoom control icon 32 may be controlled via conventional techniques, e.g., a mouse, trackball, finger or stylus on a touch-sensitive screen, etc. Moreover, the term “cursor” as used herein does not require that the cursor 30 be visually displayed in the conventional sense. For example, in the case of a position indicator like a mouse or trackball, the cursor 30 typically is visible as is conventional. In the case of a touch-sensitive screen type position indicator, however, typically the position of a cursor is represented by the position of the point of contact between the finger and/or stylus and the screen. Accordingly, there is no need for the cursor 30 in such embodiment to be visible on the display.

It will be appreciated that if the cursor 30 is moved towards the body of the scrollbar markers 26, the zoom control icon 32 does not appear. Instead, the scrollbar operation becomes conventional whereby the user may select and move the scrollbar markers 26 (e.g., by clicking-and-dragging) along the scrollbars 24 to move the window 20 across the image currently being displayed.

In the embodiment of FIG. 2B, the cursor 30 continues to appear while the zoom control icon 32 is selected an dragged. It will be appreciated, however, that another embodiment may involve the cursor 30 disappearing while the zoom control icon 32 is engaged. The present invention contemplates any and all such alternatives.

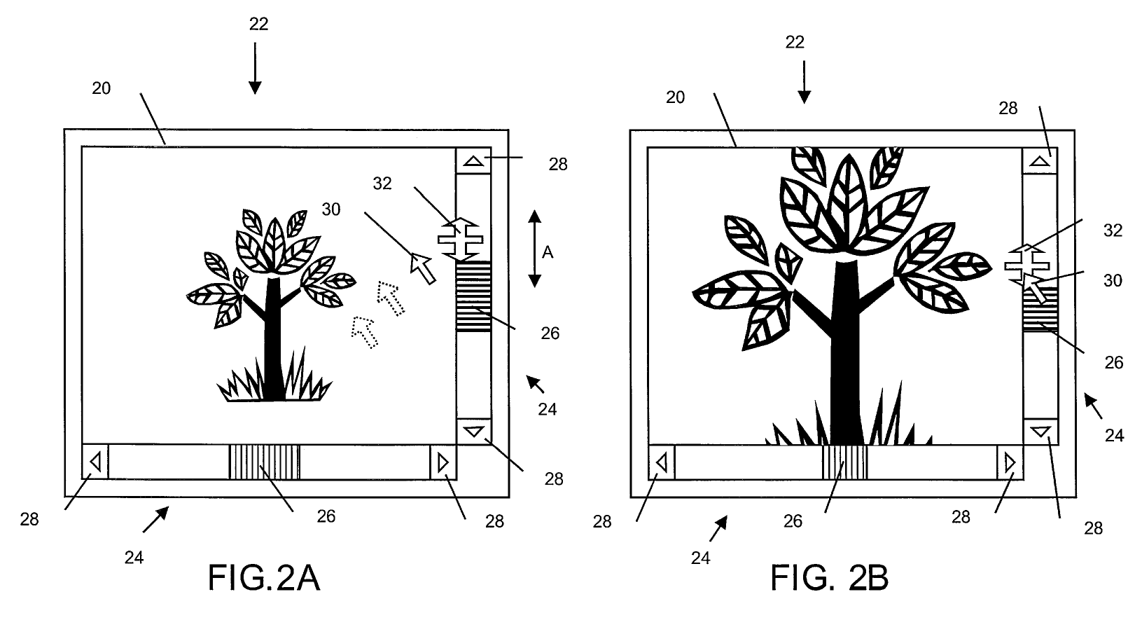

FIGS. 3A and 3B illustrate another exemplary embodiment of the present invention. In this embodiment, a user again alters the size or “zoom” level of an image displayed in the window 20 simply by engaging the scrollbar 24 itself. For example, if a user causes the cursor 30 to select the scrollbar marker 26 (e.g., by clicking) and then holds the scrollbar marker 26 (e.g., clicks-and-holds) for a predefined period of time (e.g., FIG. 3A), the electronic equipment recognizes such input and causes the length of the scrollbar marker 26 to decrease. At the same time, the electronic equipment causes a zoom in operation (e.g., FIG. 3B). In order to increase the length of the scrollbar marker 26 and thus zoom out, the user may double click and hold, for example. In either case, the size of the scrollbar markers 26 continue to progressively become shorter/longer during such time as the scrollbar markers 26 are held past the predefined period of time. Upon achieving the desired amount of zoom-in or zoom-out, the user simply releases the held scrollbar marker 26 and the zoom function ceases.

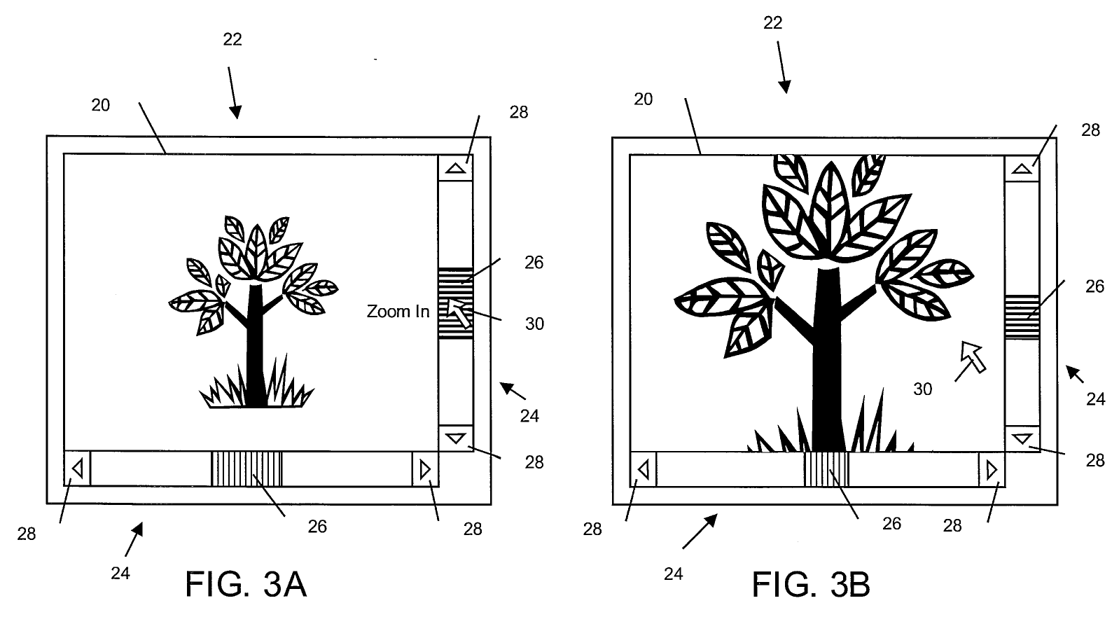

FIGS. 4A and 4B present another embodiment. In this embodiment, the user may position the cursor 30 via the position indicator over the scrollbar marker 26 and click and release quickly and/or right-click so as to prompt the electronic equipment to display zoom-in and zoom-out buttons 33 and 34, respectively, as represented in FIG. 4A. While the zoom-in and zoom-out buttons are displayed, the user may move the cursor 30 onto the desired button and press (e.g., click-and-hold). For example, if the user selects and presses the zoom-in button 33, the electronic equipment recognizes such input and causes a zoom in function while shortening the length of the scrollbar markers 26 as shown in FIG. 4B. The zoom function continues until the user releases the button.

Those having ordinary skill in the art will appreciate that a variety of methods have been shown for engaging the scrollbars 24 in order to effect a zoom function. However, they will further appreciate that there are countless other techniques associated with position indicators and graphical user interfaces which could be used to engage the scrollbars. The present invention is by no means intended to be limited to the particular methods described herein in its broadest sense.

Furthermore, the embodiments described herein have been primarily in the context of a user engaging the scrollbar marker 26 portion of the scrollbar 24. However, it is also within the scope of the present invention that portions of the scrollbar 24 other than the scrollbar marker may be similarly engaged. For example, the user may use the cursor 30 to approach the edge of the overall scrollbar 24 similar to the embodiment of FIGS. 2A and 2B. Alternatively, the user may “click-and-hold” a portion of the scrollbar 24 other than the scrollbar marker 26 as in the embodiments of FIGS. 3A, 3B and 4A, 4B. In such case, however, the electronic equipment preferably is configured not to change the position of the scrollbar marker 26 within the overall scrollbar 24 under such “click-and-hold” circumstances.

Still further, while operation of the present invention has been described primarily in the context of operation using the vertical scrollbar 24, it will be readily appreciated that like operation can be performed using the horizontal scrollbar 24 without departing from the scope of the invention.

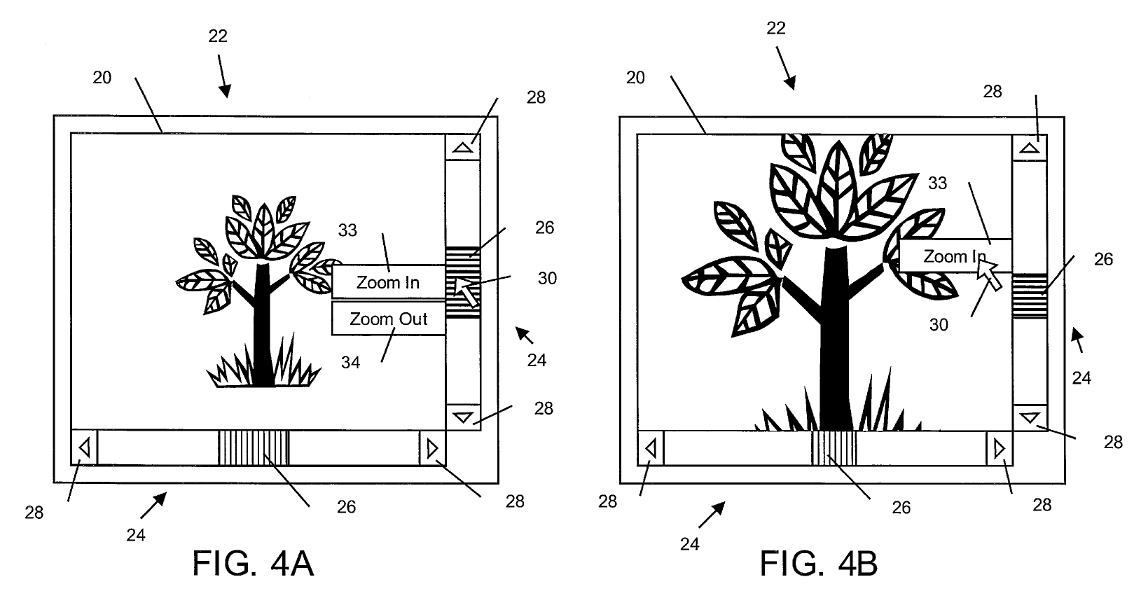

Turning now to FIG. 5, a flow chart is presented suitable for programming an electronic equipment to operate in accordance with the embodiment of FIGS. 2A-2B. In step 50, the electronic equipment determines whether the position of the cursor 30 (or finger/stylus in the case of a touch sensitive display) is near an edge of the scrollbar marker 28. If no, the electronic equipment continues to loop through step 50. If yes, the electronic equipment causes the zoom control icon 32 to be displayed as represented in step 52. Next, the electronic equipment determines in step 54 whether the zoom control icon 32 has been used to alter the length of the scrollbar marker 26. If no, the electronic equipment returns to step 50 as shown. If yes, the electronic equipment determines if the user has used the zoom control icon 32 to decrease or increase the length of the scrollbar marker 26. If decreased, the electronic equipment proceeds to step 56 in which it performs a zoom in function. If increased, the electronic equipment proceeds to step 58 and performs a zoom out function.

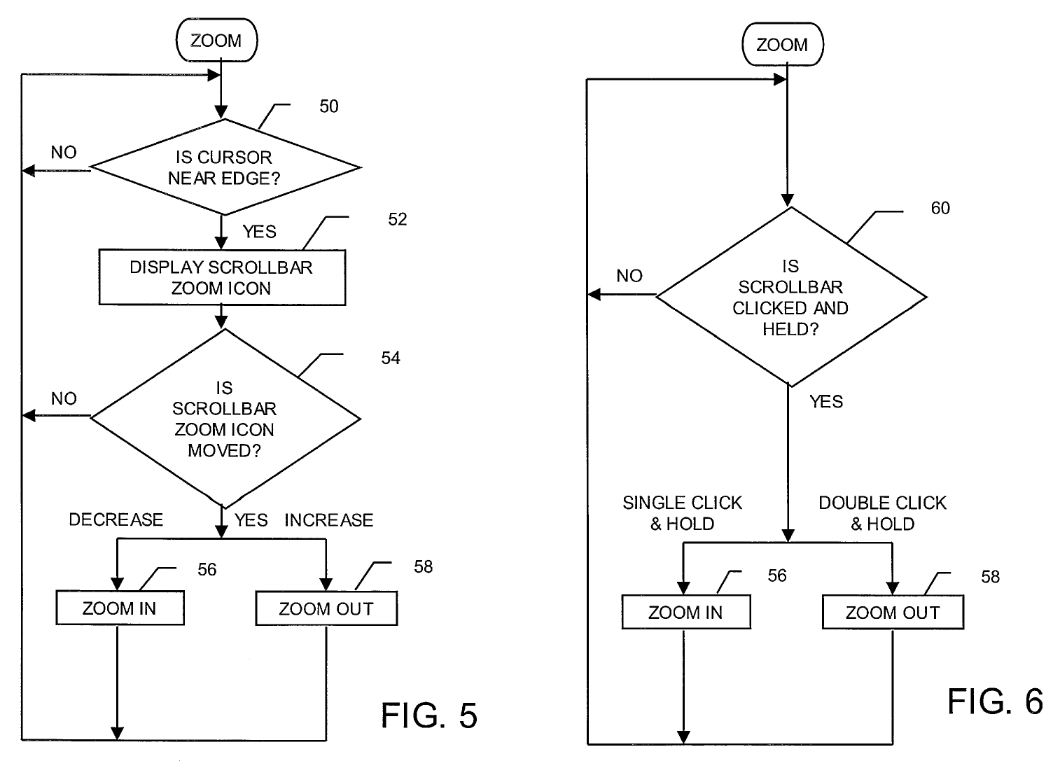

FIG. 6 illustrates operation in accordance with the embodiment of FIGS. 3A-3B. In step 60 the electronic equipment determines if the scrollbar marker 26 has been clicked-and-held for at least a predefined period of time (e.g., 0.5 second) using the position indicator. If no, the electronic equipment continues to loop around step 60 as shown. If yes, the electronic equipment determines if the click was a single click-and-hold or a double click-and-hold. If a single click-and-hold, the electronic equipment performs the zoom in function in step 56. If a double click-and-hold, the electronic equipment performs the zoom out function 58.

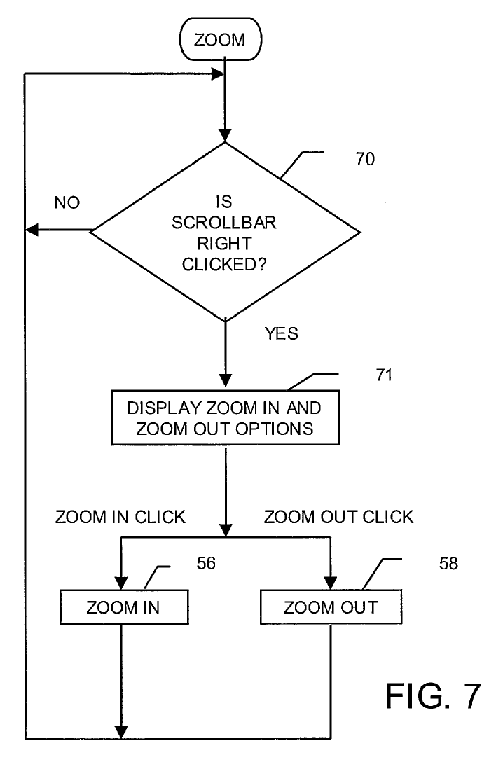

Referring to FIG. 7, a flow chart is shown representing the operation in accordance with the embodiment of FIGS. 4A-4B. In step 70, the electronic equipment determines if the scrollbar marker 26 has been rapid-clicked or right-clicked. If not, the electronic equipment continues to loop through step 70. If yes, the electronic equipment causes the display to display the zoom-in button 33 and zoom-out button 34 as represented in step 71. If the user then selects the zoom-in button 33, the electronic equipment performs the zoom in function 56. Alternatively, if the user then selects the zoom-out button 34, the electronic equipment performs the zoom out function 58.

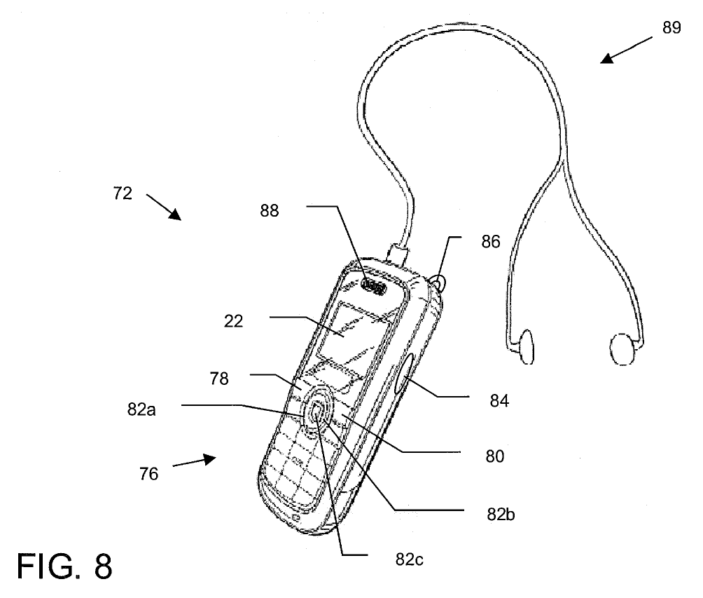

FIG. 8 illustrates an exemplary electronic equipment in accordance with the present invention in the form of a mobile phone 72. The mobile phone 72 is shown as having a “brick” or “block” design type housing, but it will be appreciated that other type housings such as clamshell or slide-type housings may be utilized without departing from the scope of the invention.

The mobile phone 72 includes a display 22 as discussed above and keypad 76. As is conventional, the display 22 may display information to a user such as operating state, time, phone numbers, contact information, various navigational menus, etc., which enable the user to utilize the various features of the mobile phone 72. In addition, the display 22 provides the scrollbar operation of the present invention as described herein. The keypad 76 may be conventional in that it provides for a variety of user input operations. For example, the keypad 76 typically includes alphanumeric keys for allowing entry of alphanumeric information such as telephone numbers, phone lists, contact information, notes, etc. In addition, the keypad 76 typically includes special function keys such as a “call send” key 78 for initiating or answering a call, and a “call end” key 80 for ending, or “hanging up” a call.

Special function keys may also include menu navigation keys 82a, 82b and 82c, for example, for navigating through a menu displayed on the display 22 to select different phone functions, profiles, settings, etc., as is conventional. Such special function keys include a position indicator that allows a user to move a cursor 30 or the like across the display. The position indicator may be a joystick button, trackball, finger or stylus on a touch sensitive screen of the display 22, etc. Other keys included in the keypad 16 may include a volume key 84, on/off power key 86, as well as various other keys such as a web browser launch key, camera key, etc.

In the particular embodiment of FIG. 8, the mobile phone 72 includes the display 22 and separate keypad 76. In an alternative embodiment, the display 22 may comprise a touchscreen which itself includes one or more keys. In yet another embodiment, the display 22 may comprise a touchscreen that includes all or substantially all of the keys used to operate the phone 10 so as to include a very limited keypad 16 or no keypad 22 at all. As will be appreciated, the particular form and function of the keys included in the keypad 76 or touchscreen/display 22 are not germane to the invention in its broadest sense.

The mobile phone 72 is a multi-functional device that is capable of carrying out various functions in addition to traditional mobile phone functions. For example, the mobile phone 72 may operate as a mobile computer incorporating windows in its display 22 as discussed herein. The mobile computer may display spreadsheets, text documents, images, movies, etc. which may require operation of the scrollbars 24 described herein. Moreover, the mobile phone 72 may utilize windows with scrollbars 24 on the display 22 as part of the present invention simply within its conventional operation as a phone. The mobile phone 10 reproduces audio through a speaker 88 or an accessory such as stereo headphones 89 which may be plugged into the mobile phone 72 via an appropriate connector.

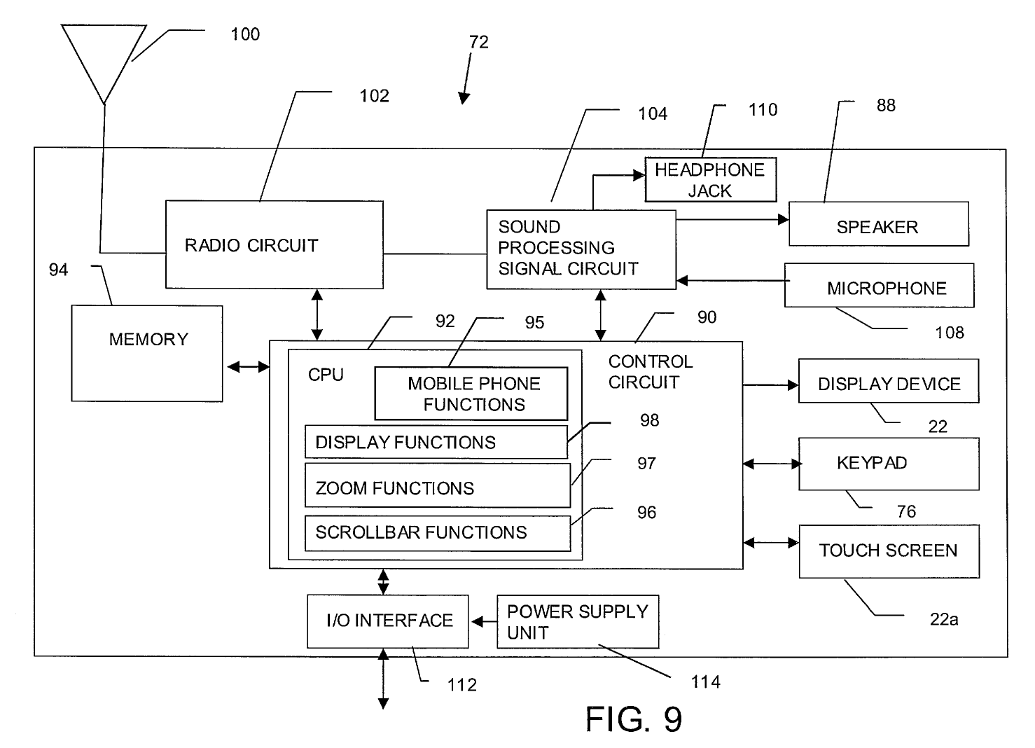

FIG. 9 represents a functional block diagram of the mobile phone 72. The construction of the mobile phone 72 is generally conventional with the exception of the scrollbar 24 operation as described herein. Preferably, the scrollbar operation is implemented primarily via application software within the mobile phone 72. However, it will be apparent to those having ordinary skill in the art that such operation can be carried out via primarily software, hardware, firmware, or combinations thereof, without departing from the scope of the invention.

The mobile phone 72 includes a primary control circuit 90 that is configured to carry out overall control of the functions and operations of the mobile phone 72. The control circuit 90 may include a CPU, microcontroller, or microprocessor, etc., collectively referred to herein simply as a CPU 92. The CPU 92 executes code stored in memory within the control circuit 90 (not shown) and/or in a separate memory 94 in order to carry out conventional operation of the mobile phone functions 95 within the mobile phone 72. In addition, however, the CPU 92 executes code stored internally or in the memory 94 in accordance with the present invention in order to perform the scrollbar functions in conjunction with zoom functions and display functions as described above in relation to the present invention. Such functions are represented by function blocks 96, 97 and 98, respectively.

A person having ordinary skill in the art of computer programming and specifically in applications programming for mobile phones and user interfaces will consider it obvious in view of the description provided herein how to program a mobile phone 72 to operate and carry out the function blocks 96, 97 and 98 as described herein. Accordingly, details as to the specific programming code have been left out for sake of brevity.

Continuing to refer to FIG. 9, the mobile phone 72 includes an antenna 100 coupled to a radio circuit 102. The radio circuit 102 includes a radio frequency transmitter and receiver for transmitting and receiving signals via the antenna 100 as is conventional. The mobile phone 72 further includes a sound processing circuit 104 for processing the audio signal transmitted by/received from the radio circuit 102. In addition, the sound processing circuit 104 serves to process the audio signal provided by the control circuit 90 during playback of media objects. Coupled to the sound processing circuit 104 are the aforementioned speaker 88, and a microphone 108 which enable a user to listen and speak via the mobile phone 72 as is conventional. In addition, a headphone jack 110 coupled to the sound processing circuit 104 is provided. This allows the headset 89 to be connected to the mobile phone 72.

The mobile phone 72 also includes the aforementioned display 22 and keypad 76 coupled to the control circuit 90. In the case where all or part of the display 22 comprises a touchscreen, such operation may be represented by the touchscreen 22a in FIG. 9. The mobile phone 72 further includes an I/O interface 112. The I/O interface 112 may be in the form of any one of many typical mobile phone I/O interfaces, such as a multi-element connector at the base of the mobile phone 72. As is typical, the I/O interface 112 may be used to couple the mobile phone 72 to a battery charger to charge a power supply unit 114 within the mobile phone 72. In addition, or in the alternative, the I/O interface 112 may serve to connect the mobile phone 72 to a wired personal hands-free adaptor (not shown) or Bluetooth adaptor (also not shown) for use with a Bluetooth-based hands-free adaptor. Further, the I/O interface 112 may serve to connect the mobile phone 72 to a personal computer or other device via a data cable, etc. As another alternative, the I/O interface 112 may serve to connect the mobile phone 10 to a docking station including an audio amplifier, speakers and/or video display to allow for enhanced viewing/listening of the media objects as part of the media player function.

In view of the above description, those having ordinary skill in the art will appreciate that the present invention provides a scrollbar configuration and method that allows a user to alter the size of the image displayed in the window without requiring an excessive number of applications of the position indicator, etc. More specifically, the present invention provides a scrollbar configuration and method that allows a user to alter the size of the image simply by engaging the scrollbar itself.

The term “electronic equipment” as referred to herein includes any type of electronic system that involves a display and graphical user interface. “Electronic equipment” includes, but is not limited to, any type of computer system, including desktop and notebook type systems, any type of portable electronic equipment, including portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electronic equipment, comprising:
a display;
a display control for presenting a window and an image within the window to the display, the window including at least one scrollbar for altering at least one of a horizontal position or a vertical position of the window relative to the image within in the window; and
a user input, operatively coupled to the display control, for engaging the at least one scrollbar in order to effect a zoom function with respect to the image displayed in the window.

2. The electronic equipment of claim 1, wherein the user input comprises a position indicator, and the display control is configured to cause the display to display a zoom control icon when the position indicator is in close proximity to a scrollbar marker included in the at least one scrollbar.

3. The electronic equipment of claim 2, wherein the zoom control icon allows a user to increase or decrease the length of the scrollbar marker to effect the zoom function.

4. The electronic equipment of claim 2, wherein the display control causes the display to display the zoom control icon when the position indicator is in close proximity to an end of the scrollbar marker.

5. The electronic equipment of claim 2, wherein the display is a touchscreen display and the placement of the position indicator is controlled via the touchscreen display.

6. The electronic equipment of claim 1, wherein the user input comprises a position indicator, and the display control is configured to effect the zoom function as a function of the position indicator selecting a scrollbar marker included in the at least one scrollbar for at least a predetermined amount of time.

7. The electronic equipment of claim 6, wherein the display control effects the zoom function in a first direction upon a single select and hold operation by the position indicator, and effects the zoom function in a second direction upon a double select and hold operation by the position indicator.

8. The electronic equipment of claim 7, wherein the display is a touchscreen display and the placement of the position indicator and selection of the scrollbar marker is controlled via the touchscreen display.

9. The electronic equipment of claim 1, wherein the user input comprises a position indicator, and the display control is configured to cause the display to display zoom control selection items when the position indicator is in close proximity to a scrollbar marker included in the at least one scrollbar.

10. The electronic equipment of claim 9, wherein the zoom control selection items include a zoom in selection item and a zoom out selection item.

11. A method for controlling an electronic equipment, the electronic equipment including a display; a display control for presenting a window and an image within the window to the display, the window including at least one scrollbar for altering at least one of a horizontal position or a vertical position of the window relative to the image within in the window; and a user input, the method comprising the steps of:
engaging the at least one scrollbar with the user input to effect a zoom function with respect to the image displayed in the window.

12. The method of claim 11, wherein the user input comprises a position indicator, and the display control is configured to cause the display to display a zoom control icon when the position indicator is placed in close proximity to a scrollbar marker included in the at least one scrollbar.

13. The method of claim 12, further comprising the step of increasing or decreasing the length of the scrollbar marker using the zoom control icon to effect the zoom function.

14. The method of claim 12, wherein the display control causes the display to display the zoom control icon when the position indicator is placed in close proximity to an end of the scrollbar marker.

15. The method of claim 12, wherein the display is a touchscreen display and the placement of the position indicator is controlled via the touchscreen display.

16. The method of claim 11, comprising the step of selecting a scrollbar marker included in the at least one scrollbar for at least a predetermined amount of time in order to effect the zoom function.

17. The method of claim 16, wherein the display control effects the zoom function in a first direction upon a single select and hold operation of the at least one scrollbar, and effects the zoom function in a second direction upon a double select and hold operation of the at least one scrollbar.

18. The method of claim 17, wherein the display is a touchscreen display and the selection of the scrollbar marker is controlled via the touchscreen display.

19. The method of claim 11, wherein the display control is configured to cause the display to display zoom control selection items when the scrollbar marker is addressed by the user input.

20. The method of claim 19, wherein the zoom control selection items include a zoom in selection item and a zoom out selection item.
